(19) United States
(12) Patent Application Publication
(10) Pub. No.: US 2026/0172230 A1
(43) Pub. Date: Jun. 18, 2026

(54) FAST BASIC SERVICE SET TRANSITION INITIAL MOBILITY DOMAIN ASSOCIATION WITH ENCRYPTING ASSOCIATION REQUEST/RESPONSE

(71) Applicant: Intel Corporation, Santa Clara, CA (US)

(72) Inventors: Po-Kai Huang, San Ramon, CA (US); Johannes Berg, Detmold (DE); Ido Ouzieli, Tel Aviv (IL); Ilan Peer, Modiin (IL)

(21) Appl. No.: 19/535,650

(22) Filed: Feb. 10, 2026

Related U.S. Application Data
(60) Provisional application No. 63/757,219, filed on Feb. 11, 2025.
(60) Provisional application No. 63/871,264, filed on Aug. 27, 2025.

(51) Int. Cl. H04L 9/08; H04L 9/32

(52) U.S. Cl. CPC H04L 9/0822; H04L 9/32

(57) ABSTRACT

This disclosure describes systems, methods, and devices related to enhanced connectivity. A device may determine, based on a Robust Security Network Extension (RSNXE) field, whether a (Re)Association Frame Encryption Support indication equals one. The device may transmit an authentication frame to initiate fast transition initial mobility domain association. The device may process a second authentication frame received from a fast transition responder (FTR) by extracting a fast transition element (FTE) and a mobility domain element (MDE). The device may establish a pairwise master key security association (PMKSA) based on the extracted FTE and MDE.

### CROSS-REFERENCE TO RELATED APPLICATION(S)

This application claims the benefit of U.S. Provisional Application No. 63/757,219, filed Feb. 11, 2025, and U.S. Provisional Application No. 63/871,264, filed Aug. 27, 2025, the disclosures of which are incorporated herein by reference as if set forth in full.

### BACKGROUND

Wireless devices are becoming more prevalent, necessitating efficient access to wireless channels. Standards are evolving to enhance connectivity, integrating advanced technologies in modern networks.

### BRIEF DESCRIPTION OF THE DRAWINGS

FIG. 1 is a network diagram illustrating an example network environment for enhanced connectivity, in accordance with one or more example embodiments of the present disclosure.

FIG. 2 depicts an illustrative schematic diagram for optimized secure association, in accordance with one or more example embodiments of the present disclosure.

FIG. 3 illustrates a flow of a process for an illustrative enhanced connectivity system, in accordance with one or more example embodiments of the present disclosure.

FIG. 4 illustrates a functional diagram of an exemplary communication station that may be suitable for use as a user device, in accordance with one or more example embodiments of the present disclosure.

FIG. 5 illustrates a block diagram of an example machine upon which any of one or more techniques (e.g., methods) may be performed, in accordance with one or more example embodiments of the present disclosure.

FIG. 6 is a block diagram of a radio architecture in accordance with some examples.

FIG. 7 illustrates an example front-end module circuitry for use in the radio architecture of FIG. 6, in accordance with one or more example embodiments of the present disclosure.

FIG. 8 illustrates an example radio IC circuitry for use in the radio architecture of FIG. 6, in accordance with one or more example embodiments of the present disclosure.

FIG. 9 illustrates an example baseband processing circuitry for use in the radio architecture of FIG. 6, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

Fast BSS transition is a protocol to enhance roaming. To enable fast roaming, FT key hierarchy is required to be established in the initial association to the mobility domain supporting FT. The current 802.11bi specification does not accommodate FT initial domain association, which requires inclusion of mobility domain element (MDE), FTE, PMKRIName in various sequence exchange. There are no previous solutions to solve this problem.

### Password Identifier:

Password identifier is a mechanism introduced under Simultaneous authentication of equals (SAE) in 802.11 to allow multiple passwords to be used under one SSID. Specifically, a password to be used under SAE is identified by a password identifier carried in the password identifier element in the first authentication frame of SAE exchange. Then the peer can identify the proper password to proceed the authentication.

Most likely the password identifier and password will be handled over the user with the approach of how to hand the password to the user today.

A home owner configures the password and password identifier to the wi-fi router and hand over to the family members.

A landlord configures the password and password identifier to the wi-fi router and hand over to the tenants. Say user 1 gets password identifier 1 and password 1 to be used with device 1, device 2.

### Change of Password Identifier:

In IEEE 802.11bi (“11bi”), an approach has been proposed to change the used password. Specifically, after a password identifier is used for authentication, then AP will assign another password identifier to be used next time. Then the spec mandates that both AP and the non-AP STA delete the previous assigned password identifiers. The motivation for this action is to make sure that different password identifiers are used on the clear as frequent as possible to avoid privacy issue.

Both the AP and the non-AP STA shall delete previously assigned password identifiers when a new set is delivered in a successfully completed 4-way handshake.

Although with the good intention, deleting the original assigned password identifiers (say by landlord as described in the previous example) on both AP and non-AP STA is not a good practice.

Specifically, if the assigned password identifier 1 is used by device 1 of user 1, and then user 1 wants to connect device 2, then the assigned password identifier 1 cannot be used anymore since password identifier 1 is deleted. User 1 then have to get another password identifier from the landlord, which then makes the process of assigning password identifier much more complicated.

The same problem also happens when device 1 resets and wipes out all new password identifiers assigned by the AP. In this case, device 1 may pop out screen for user 1 to enter password and password identifier. User 1 will only know the original assigned password identifier 1 and password, but when user 1 enters that it does not work anymore.

There is no previous solution since the existing solution has the problem as described.

Example embodiments of the present disclosure relate to systems, methods, and devices for fast basic service set (BSS) transition (FT) initial mobility domain association with encrypting association request/response.

Additional example embodiments of the present disclosure relate to systems, methods, and devices for [11bi] Mechanism for configured password identifier.

In one embodiment, an enhanced connectivity system may facilitate to clearly separate two kinds of password identifiers in the 802.11 specification (“spec”).
The password identifier that is configured out of band.
The password identifier that is further assigned through wireless message exchange.

Then it is proposed to have different password identifier change procedure for these two cases.
The password identifier that is configured out of band shall not be deleted.
The password identifier that is further assigned through wireless message exchange can be deleted.

One or more advantages include: the assignment of password and password identifier out of band will not be further complicated.

In one or more embodiments, a device or a system may comprise one or more components, which may include one or more of: apparatus, station (STA), access point (AP), and/or other network elements. At its most basic configuration, the device or system includes one or more processors, memory, and instructions. The processor(s) may be implemented using general-purpose microprocessors, digital signal processors (DSPs), field-programmable gate arrays (FPGAs), or other suitable computational entities capable of performing calculations or manipulations of information. The memory may include RAM, ROM, flash memory, or other storage media suitable for storing instructions and data necessary for system operation. These components, individually or in combination, enable the execution of processes that facilitate communication and functionality within the system.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

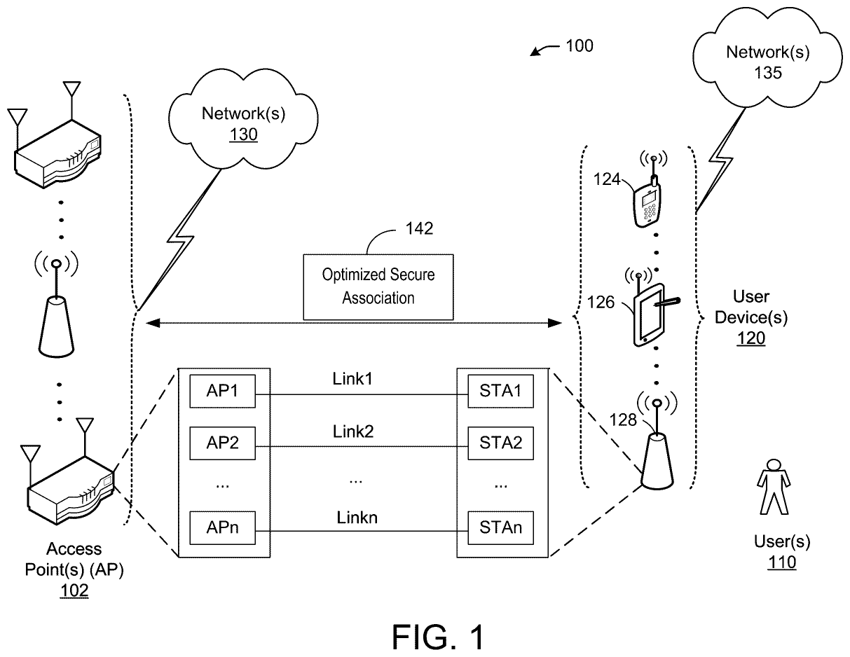

FIG. 1 is a network diagram illustrating an example network environment of enhanced connectivity, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

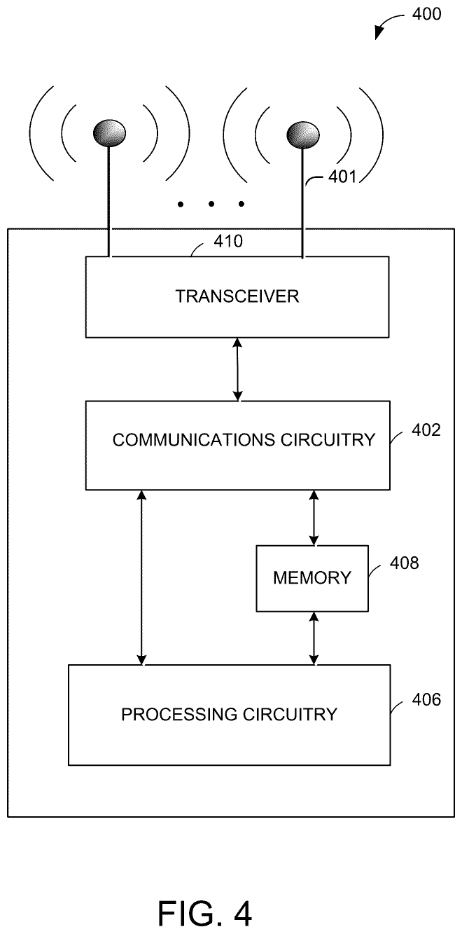

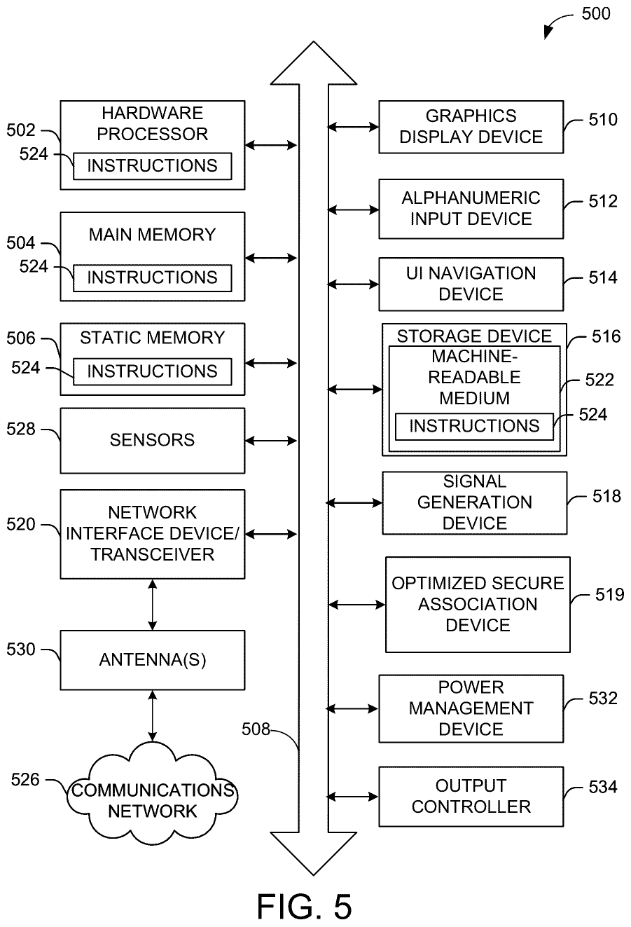

In some embodiments, the user devices 120 and the AP 102 may include one or more computer systems similar to that of the functional diagram of FIG. 4 and/or the example machine/system of FIG. 5.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an enhanced connectivity 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

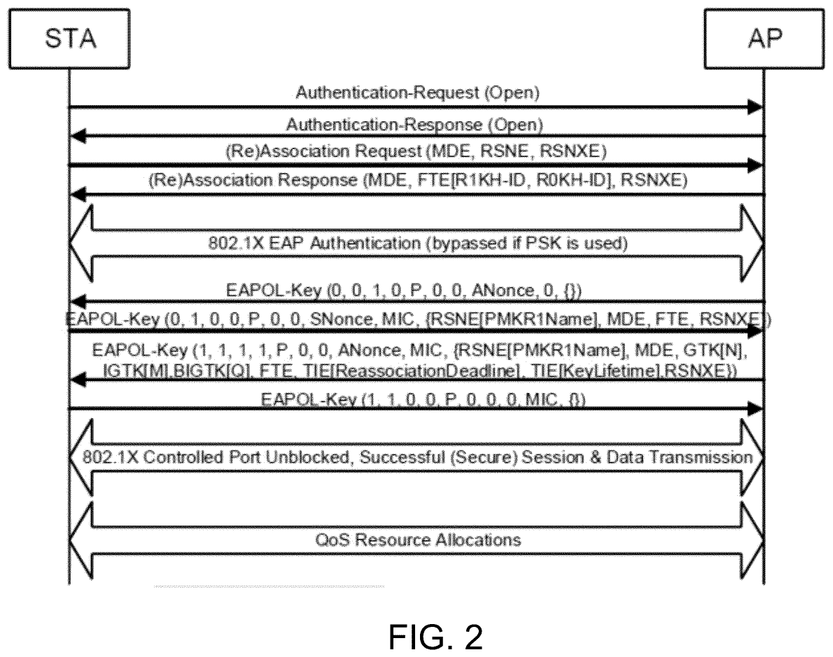

FIG. 2 depicts an illustrative schematic diagram for optimized secure association, in accordance with one or more example embodiments of the present disclosure.

Referring to FIG. 2, there is shown an FT initial mobility domain association in an RSN using Open System authentication.

Fast BSS transition is a protocol to enhance roaming. To enable fast roaming, FT key hierarchy is required to be established in the initial association to the mobility domain supporting FT. An example of initial domain association using 802.1X is shown below in FIG. 2.

Note that MDE is required to be included in (Re)Association Request/Response frame. MDE in the (Re)Association Request frame is verified to be the same as Beacon/Probe Response frame. AKM in the (Re)Association Request frame is verified to be FT AKM.

While both terms describe the handshake that establishes a data link between a device and an Access Point, the distinction lies entirely in the state of the connection at the time of the request. Association is the fundamental “first-time” entry into a network, occurring after a device has discovered a new SSID and completed the initial authentication, effectively creating a brand-new registration in the Access Point's table. In contrast, Reassociation is a specialized “handover” request used during roaming, where the device informs a new Access Point that it is already a member of the extended network and wishes to migrate its existing session from a previous radio without starting the connection process from scratch.

The notation (Re)Association is used as a functional shorthand to indicate that a specific requirement, such as the inclusion of a Mobility Domain Element, applies universally to both the initial Association and any subsequent Reassociation frames. By nesting the prefix in parentheses, the protocol emphasizes that the security and identity checks remain identical whether a device is establishing a fresh connection or transitioning an active session between access points.

FTE with R1KH-ID and ROKH-ID is required to be included in the (Re)Association Response frame. After 802.1X authentication, FT 4-way handshake is used, where PMKR1Name, MDE, FTE are included in Message 2 and PMKR1Name, MDE, FTE are included in message 3. MDE, FTE Information in message 2 is verified to be the same as the ones in (Re)Association Response. PMKR1Name in message 2 is verified to follow the calculation. MDE, FTE Information in message 3 is verified to be the same as the ones in (Re)Association Response. PMKRIName in message 3 is verified to be the same as message 2.

11bi defines encryption of (Re)Association Request/Response to avoid element fingerprinting of the large amounts of elements in the (Re)Association Request/Response frame. To encrypt them, PTKSA is derived with Authentication frame exchange, and there is no need for additional 4-way handshake.

However, the current 11bi specification does not accommodate FT initial domain association, which requires inclusion of MDE, FTE, PMKR1Name in various sequence exchanges.

Starting with the rules of MDE and FTE in authentication frame exchange for FT initial domain association to encrypt (re) association request/response.
If an FTO or FTR (Fast BSS transition) sets the (Re)Association Frame Encryption Support field in the RSNXE to 1, then the FTO or FTR supports the additional rules defined in this subclause to initiate FT initial mobility domain association. It should be understood that (Re)Association, means Reassociation or Association.
An FTO that has dot11EDPReAssociationFrameEncryptionSupportActivated equal to true and receives the RSNXE from the FTR with the (Re)Association Frame Encryption Support field set to 1 shall do the following to initial FT initial mobility domain association:
The first Authentication frame carries MDE. The contents of the MDE shall be the values advertised by the AP that receives the first Authentication frame in its Beacon or Probe Response frames.
If the contents of the MDE received in the first Authentication frame do not match the contents advertised in the Beacon or Probe Response frames, the processing status is set to STATUS_INVALID_MDE. If an MDE is present in the first Authentication frame and the base AKMP does not indicate the single FT AKMP, the processing status is set to STATUS_INVALID_AKMP.
The second Authentication frame carries MDE and FTE. The MDE has contents as presented in Beacon and Probe Response frames. The FTE shall include the key holder identities, the ROKH-ID and RIKH-ID, set to the values of dot11FTROKeyHolderID and dot11FTRIKeyHolderID, respectively. The FTE shall have a MIC element count of zero (i.e., no MIC present) and have ANonce, SNonce, and MIC fields set to 0.
Upon successful completion Authentication frame processing to establish PMKSA, the ROKH establishes key hierarchy. If a key hierarchy already exists for the FTO belonging to the same mobility domain (i.e., having the same MDID), the ROKH shall delete the existing PMK-R0 security association and PMK-R1 security associations. It then calculates the PMK-R0, PMKR0Name, and PMK-R1 and makes the PMK-R1 available to the RIKH.

Starting with the rules of MDE and FTE in encrypted (re) association frame exchange for FT initial domain association for non-multi-link operation (MLO).
If FT initial mobility domain association is used, then the EDP non-AP STA shall include MDE and FTE in the (Re)Association Request frame. MDE and FTE shall be the same as the ones in the second Authentication frame.
If FT initial mobility domain association is used, then the PMKRIName shall be included in the RSNE in the (Re)Association Request frame. The PMKRIName shall be as calculated by the SIKH according to the procedures of 12.7.1.6.4 (PMK-R1).
For the RSNE other than the Length field, the PMKID Count field and the PMKID list field included in the (Re)Association Request frame shall be identical to those in the RSNE present in the first Authentication frame.
If FT initial mobility domain association is used, then the FTE and MDE in the (Re)Association Request frame are checked to be the same as those provided in the second Authentication frame as defined in 12.16.8.1a (FT initial mobility domain association). If the MDE check fails, the (Re)Association Request frame is rejected with status code STATUS_INVALID_MDE. If the FTE check fails, the (Re)Association Request frame is rejected with status code STATUS_INVALID_FTE.
If FT initial mobility domain association is used, then the PMKRIName in the RSNE in the (Re)Association Request frame is checked to be included and calculated according to the procedures of 12.7.1.6.4 (PMK-R1). If the check fails, the (Re)Association Request frame is rejected with status code STATUS_INVALID_PMKID.
The EDP AP shall verify that the RSNE fields other than the Length field, the PMKID Count field and the PMKID list field in the (Re)Association Request frame is identical to the RSNE fields included in the first Authentication frame. The EDP AP shall also verify that the RSNXE in the (Re)Association Request frame is identical to the RSNXE included in the first Authentication frame. If the validation fails, the EDP AP shall reject the association.
If FT initial mobility domain association is used, then EDP AP shall include MDE and FTE in the (Re)Association Response frame. MDE and FTE shall be the same as the ones in the second Authentication frame as described in 12.16.8.1a (FT initial mobility domain association).
If FT initial mobility domain association is used, then the PMKRIName shall be included in the RSNE in the (Re)Association Response frame. The PMKRIName shall be as calculated by the R1KH according to the procedures of 12.7.1.6.4 (PMK-R1).
If FT initial mobility domain association is used, then the FTE and MDE in the (Re)Association Response frame are checked to be the same as those provided in the second Authentication frame as defined in 12.16.8.1a (FT initial mobility domain association). If the check fails, the EDP non-AP STA shall discard the response.
If FT initial mobility domain association is used, then the PMKRIName in the RSNE in the (Re)Association Response frame is checked to be included and identical to the value that is sent in the Association Request frame. If the check fails, the EDP non-AP STA shall discard the response.
If the FT initial mobility domain association is used and in the (Re)Association Response frame the RSNE fields other than the Length field, the PMKID Count field and the PMKID list field are not identical to the corresponding RSNE fields in the Beacon or Probe Response frames received from the EDP AP, the EDP non-AP STA shall discard the response.

Starting with the rules of MDE and FTE in encrypted (re) association frame exchange for FT initial domain association for non-multi-link operation (MLO).
If FT initial mobility domain association is used, then the EDP non-AP MLD shall include MDE and FTE in the (Re)Association Request frame. MDE and FTE shall be the same as the ones in the second Authentication frame.
If FT initial mobility domain association is used, then the PMKRIName shall be included in the RSNE in the (Re)Association Request frame. The PMKRIName shall be as calculated by the SIKH according to the procedures of 12.7.1.6.4 (PMK-R1).
The EDP non-AP STA shall verify that the RSNE fields other than the Length field, the PMKID Count field and the PMKID list field included in the (Re)Association Request frame is identical to the RSNE fields in the first Authentication frame.
If FT initial mobility domain association is used, then the FTE and MDE in the (Re)Association Request frame are checked to be the same as those provided in the second Authentication frame. If the MDE check fails, the (Re)Association Request frame is rejected with status code STATUS_INVALID_MDE. If the FTE check fails, the (Re)Association Request frame is rejected with status code STATUS_INVALID_FTE.
If FT initial mobility domain association is used, then the PMKRIName in the RSNE in the (Re)Association Request frame is checked to be included and calculated according to the procedures of 12.7.1.6.4 (PMK-R1). If the check fails, the (Re)Association Request frame is rejected with status code STATUS_INVALID_PMKID.
The EDP AP MLD shall verify that the RSNE fields other than the Length field, the PMKID Count field and the PMKID list field in the (Re)Association Request frame is identical to the RSNE fields included in the first Authentication frame. The EDP AP MLD shall also verify that the RSNXE in the (Re)Association Request frame is identical to the RSNXE included in the first Authentication frame. If the validation fails, the EDP AP MLD shall reject the association.
If FT initial mobility domain association is used, then EDP AP MLD shall include MDE and FTE in the (Re)Association Response frame. MDE and FTE shall be the same as the ones in the second Authentication frame.
If FT initial mobility domain association is used, then the PMKRIName shall be included in the RSNE in the (Re)Association Response frame. The PMKRIName shall be as calculated by the R1KH according to the procedures of 12.7.1.6.4 (PMK-R1).
If FT initial mobility domain association is used, then the FTE and MDE in the (Re)Association Response frame are checked to be the same as those provided in the second Authentication frame as defined in 12.16.8.1a (FT initial mobility domain association). If the check fails, the EDP non-AP MLD shall discard the response.
If FT initial mobility domain association is used, then the PMKRIName in the RSNE in the (Re)Association Response frame is checked to be included and identical to the value that is sent in the (Re)Association Request frame. If the check fails, the EDP non-AP MLD shall discard the response.
If the FT initial mobility domain association is used and in the (Re)Association Response frame the RSNE fields other than the Length field, the PMKID Count field and the PMKID list field corresponding to each link are not identical to the corresponding RSNE fields of the link in the Beacon or Probe Response frames received from the corresponding AP affiliated with the EDP AP MLD or in the multi-link probe response received from the EDP AP MLD, the EDP non-AP MLD shall discard the response.

Finalizing with allowed FT related AKM in EDPKE.

For EDPKE, SAE AKMP 00-OF-AC: 9 and 00-OF-AC: 25 can be used as the Base AKMP.

For EDPKE, if the base AKMP is FT AKMP, then PMK-R1 is used to derive the PTK.

It is understood that the above descriptions are for the purposes of illustration and are not meant to be limiting.

In one or more embodiments, an enhanced connectivity system may facilitate to differentiate two kinds of password identifier:
Password identifier that is not assigned from the peer SAE entity.
Password identifier that is assigned from the peer SAE entity. The SAE Password Identifiers in the SAE Password Identifiers KDE are an example for the peer SAE entity to assign SAE password identifiers.

Then it is proposed to limit the deleting rule for SAE Password Identifiers only for the SAE Password Identifiers assigned from the peer SAE entity: If both SAE entities have set SAE Password Identifier Change Support to 1, then the SAE Password Identifiers assigned from the peer SAE entity might be deleted after the password identifier has been used to finish a successful SAE authentication.

Then it is proposed to add SAE Password Identifiers KDE in encrypted (re) association request/response since 4-way handshake may not be used all the time:
If a Key Delivery element is included in the encrypted (Re)Association Response frame, the EPP AP or EPP AP MLD shall construct the Key Delivery element with the SAE Password Identifiers KDE if the EPP AP or EPP AP MLD supports SAE password identifier change and the non-AP STA or the non-AP MLD sets the SAE Password Identifier Change Support bit in the RSNXE to 1.
For FILS that includes a Key Delivery element in the (Re)Association Response frame, the EPP AP or EPP AP MLD shall construct the Key Delivery element with the SAE Password Identifiers KDE if the EPP AP or EPP AP MLD supports SAE password identifier change and the non-AP STA or the non-AP MLD sets the SAE Password Identifier Change Support bit in the RSNXE to 1.

In the case that the 4-way handshake is used, it is proposed that the new SAE password identifier is delivered only if the peer supports SAE Password identifier change.

The AP or AP MLD shall include SAE Password Identifiers KDE in message 3 of 4-way handshake if the EPP AP or EPP AP MLD supports SAE password identifier change and the non-AP STA or the non-AP MLD sets the SAE Password Identifier Change Support bit in the RSNXE to 1.

Currently, the 802.11 specification (“spec”) mentions that “When an AP in an ESS provides a list of password identifiers, those new password identifiers can be used with all APs in the ESS.” It is proposed to make sure that this is only the case if the exchange to deliver SAE password identifier is successful.

When an AP or AP MLD in an ESS provides a list of password identifiers in a successful 4-way handshake or in a successful (re) association request/response exchange, those new password identifiers can be used with all APs or AP MLDs in the ESS.

Some AP vendors may implement an approach to easily sync the assigned password identifier to be used across all APs in the same ESS by synchronize a key to encrypt the password identifier to be delivered and sends the encrypted version to the non-AP STA or the non-AP MLD. In this case, it is proposed that:

When the AP or AP MLD receives the password identifier in the password identifier element, it will:
First, check if the password identifier matches any stored password identifier, if so proceed authentication with the corresponding password.
If the password identifier does not match any stored password identifier, then decrypt the password identifier string with the key. If the decryption is not successful, then reject the authentication.
If the decryption is successful, then extract the password identifier from the decrypted string and check if the password identifier matches any stored password identifier, if so proceed authentication with the corresponding password. If not, reject the authentication.

It is understood that the above descriptions are for the purposes of illustration and are not meant to be limiting.

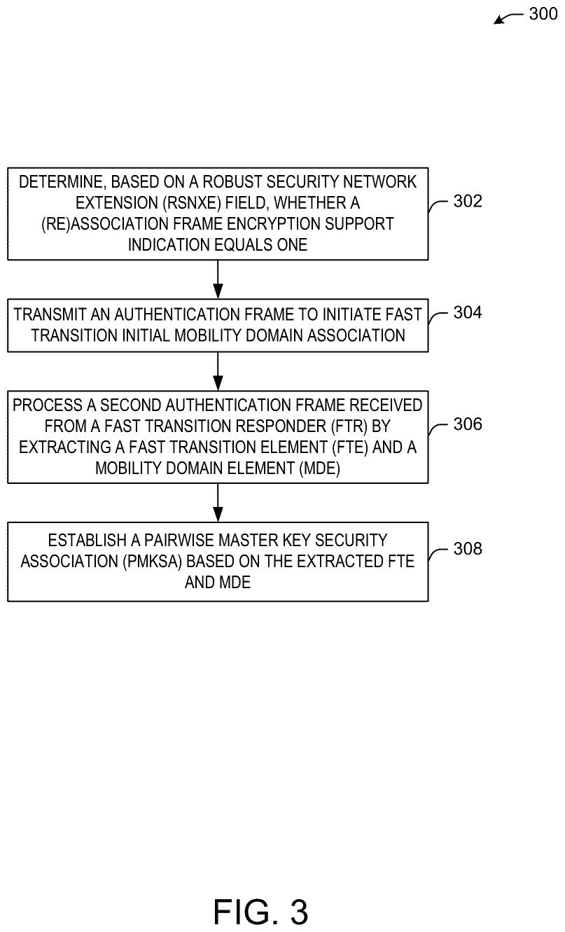

FIG. 3 illustrates a flow of illustrative process 300 for an enhanced connectivity system, in accordance with one or more example embodiments of the present disclosure.

At block 302, a device (e.g., the user device(s) 120 and/or the AP 102 of FIG. 1 and/or the optimized secure association device 519 of FIG. 5) may determine, based on a Robust Security Network Extension (RSNXE) field, whether a (Re)Association Frame Encryption Support indication equals one.

At block 304, the device may transmit an authentication frame to initiate fast transition initial mobility domain association.

At block 306, the device may process a second authentication frame received from a fast transition responder (FTR) by extracting a fast transition element (FTE) and a mobility domain element (MDE).

At block 306, the device may establish a pairwise master key security association (PMKSA) based on the extracted FTE and MDE.

In one or more embodiments, a device or a system may address the need for secure and efficient transitions within wireless network environments. The device may be designed to determine, based on a RSNXE field, whether a (Re)Association Frame Encryption Support indication equals one. This capability may provide enhanced adaptability in environments where encryption support is variable, thereby supporting robust security protocols and improving trust in the network infrastructure. For example, the device may detect the encryption support status in real time to decide whether to proceed with secure association procedures.

In one or more embodiments, the device may transmit an authentication frame to initiate fast transition initial mobility domain association. This approach may facilitate seamless network transitions, which is particularly advantageous in high-mobility environments such as enterprise campuses or transportation hubs. The device may further process a second authentication frame received from a fast transition responder by extracting a FTE and an MDE. Such processing may enable the device to establish a PMKSA based on the extracted FTE and MDE, thereby maintaining secure connectivity during mobility events. As an example, the device may initiate a handshake with a new access point and dynamically extract the necessary elements to complete secure reassociation without user intervention.

In one or more embodiments, the device may include an MDE in the first authentication frame, ensuring that this element is equal to the MDE advertised in Beacon or Probe Response frames from the FTR or an affiliated AP of the FTR. This alignment may help guarantee that the device's authentication attempts are valid for the intended mobility domain, reducing the risk of failed or insecure transitions. The device may also process the FTE in the second authentication frame by extracting key holder identities, such as ROKH-ID and R1KH-ID, which may be critical for deriving or validating key hierarchies necessary for secure roaming. For instance, the device may cross-check key holder identities to confirm the authenticity of the responding entity before completing the key establishment process.

It is understood that the above descriptions are for the purposes of illustration and are not meant to be limiting.

FIG. 4 shows a functional diagram of an exemplary communication station 400, in accordance with one or more example embodiments of the present disclosure. In one embodiment, FIG. 4 illustrates a functional block diagram of a communication station that may be suitable for use as an AP 102 (FIG. 1) or a user device 120 (FIG. 1) in accordance with some embodiments. The communication station 400 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 400 may include communications circuitry 402 and a transceiver 410 for transmitting and receiving signals to and from other communication stations using one or more antennas 401. The communications circuitry 402 may include circuitry that can operate the physical layer (PHY) communications and/or medium access control (MAC) communications for controlling access to the wireless medium, and/or any other communications layers for transmitting and receiving signals. The communication station 400 may also include processing circuitry 406 and memory 408 arranged to perform the operations described herein. In some embodiments, the communications circuitry 402 and the processing circuitry 406 may be configured to perform operations detailed in the above figures, diagrams, and flows.

In accordance with some embodiments, the communications circuitry 402 may be arranged to contend for a wireless medium and configure frames or packets for communicating over the wireless medium. The communications circuitry 402 may be arranged to transmit and receive signals. The communications circuitry 402 may also include circuitry for modulation/demodulation, upconversion/downconversion, filtering, amplification, etc. In some embodiments, the processing circuitry 406 of the communication station 400 may include one or more processors. In other embodiments, two or more antennas 401 may be coupled to the communications circuitry 402 arranged for sending and receiving signals. The memory 408 may store information for configuring the processing circuitry 406 to perform operations for configuring and transmitting message frames and performing the various operations described herein. The memory 408 may include any type of memory, including non-transitory memory, for storing information in a form readable by a machine (e.g., a computer). For example, the memory 408 may include a computer-readable storage device, read-only memory (ROM), random-access memory (RAM), magnetic disk storage media, optical storage media, flash-memory devices and other storage devices and media.

In some embodiments, the communication station 400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 400 may include one or more antennas 401. The antennas 401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 400 may include one or more of a keyboard, a display, a non-volatile memory port, multiple antennas, a graphics processor, an application processor, speakers, and other mobile device elements. The display may be an LCD screen including a touch screen.

Although the communication station 400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 400 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 400 may include one or more processors and may be configured with instructions stored on a computer-readable storage device.

FIG. 5 illustrates a block diagram of an example of a machine 500 or system upon which any one or more of the techniques (e.g., methodologies) discussed herein may be performed. In other embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environments. The machine 500 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a power management device 532, a graphics display device 510, an alphanumeric input device 512 (e.g., a keyboard), and a user interface (UI) navigation device 514 (e.g., a mouse). In an example, the graphics display device 510, alphanumeric input device 512, and UI navigation device 514 may be a touch screen display. The machine 500 may additionally include a storage device (i.e., drive unit) 516, a signal generation device 518 (e.g., a speaker), an enhanced connectivity device 519, a network interface device/transceiver 520 coupled to antenna(s) 530, and one or more sensors 528, such as a global positioning system (GPS) sensor, a compass, an accelerometer, or other sensor. The machine 500 may include an output controller 534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 502 for generation and processing of the baseband signals and for controlling operations of the main memory 504, the storage device 516, and/or the enhanced connectivity device 519. The baseband processor may be provided on a single radio card, a single chip, or an integrated circuit (IC).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within the static memory 506, or within the hardware processor 502 during execution thereof by the machine 500. In an example, one or any combination of the hardware processor 502, the main memory 504, the static memory 506, or the storage device 516 may constitute machine-readable media.

The enhanced connectivity device 519 may carry out or perform any of the operations and processes (e.g., process 300) described and shown above.

It is understood that the above are only a subset of what the enhanced connectivity device 519 may be configured to perform and that other functions included throughout this disclosure may also be performed by the enhanced connectivity device 519.

While the machine-readable medium 522 is illustrated as a single medium, the term “machine-readable medium” may include a single medium or multiple media (e.g., a centralized or distributed database, and/or associated caches and servers) configured to store the one or more instructions 524.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device/transceiver 520 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 520 may include one or more physical jacks (e.g., Ethernet, coaxial, or phone jacks) or one or more antennas to connect to the communications network 526. In an example, the network interface device/transceiver 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 500 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

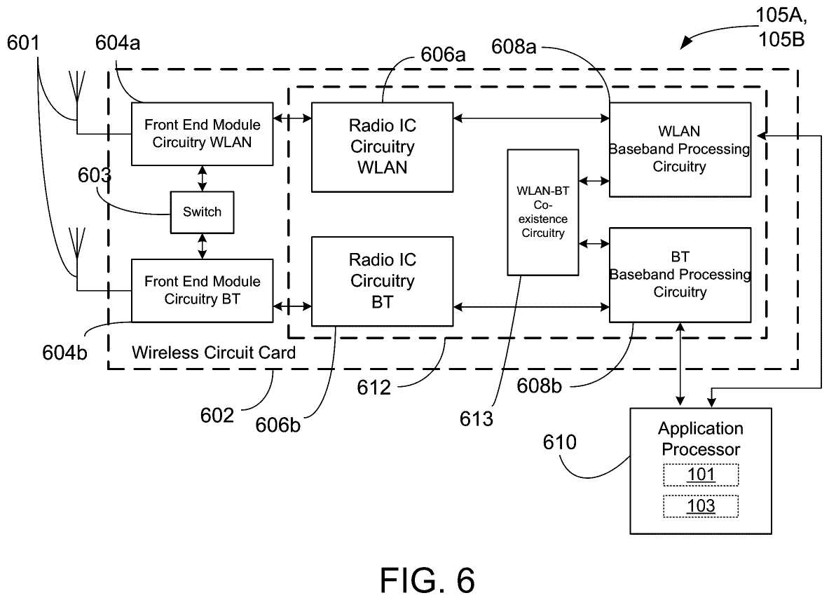

FIG. 6 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 604a-b, radio IC circuitry 606a-b and baseband processing circuitry 608a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 604a-b may include a WLAN or Wi-Fi FEM circuitry 604a and a Bluetooth (BT) FEM circuitry 604b. The WLAN FEM circuitry 604a may include a receive signal path comprising circuitry configured to operate on WLAN RF signals received from one or more antennas 601, to amplify the received signals and to provide the amplified versions of the received signals to the WLAN radio IC circuitry 606a for further processing. The BT FEM circuitry 604b may include a receive signal path which may include circuitry configured to operate on BT RF signals received from one or more antennas 601, to amplify the received signals and to provide the amplified versions of the received signals to the BT radio IC circuitry 606b for further processing. FEM circuitry 604a may also include a transmit signal path which may include circuitry configured to amplify WLAN signals provided by the radio IC circuitry 606a for wireless transmission by one or more of the antennas 601. In addition, FEM circuitry 604b may also include a transmit signal path which may include circuitry configured to amplify BT signals provided by the radio IC circuitry 606b for wireless transmission by the one or more antennas. In the embodiment of FIG. 6, although FEM 604a and FEM 604b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 606a-b as shown may include WLAN radio IC circuitry 606a and BT radio IC circuitry 606b. The WLAN radio IC circuitry 606a may include a receive signal path which may include circuitry to down-convert WLAN RF signals received from the FEM circuitry 604a and provide baseband signals to WLAN baseband processing circuitry 608a. BT radio IC circuitry 606b may in turn include a receive signal path which may include circuitry to down-convert BT RF signals received from the FEM circuitry 604b and provide baseband signals to BT baseband processing circuitry 608b. WLAN radio IC circuitry 606a may also include a transmit signal path which may include circuitry to up-convert WLAN baseband signals provided by the WLAN baseband processing circuitry 608a and provide WLAN RF output signals to the FEM circuitry 604a for subsequent wireless transmission by the one or more antennas 601. BT radio IC circuitry 606b may also include a transmit signal path which may include circuitry to up-convert BT baseband signals provided by the BT baseband processing circuitry 608b and provide BT RF output signals to the FEM circuitry 604b for subsequent wireless transmission by the one or more antennas 601. In the embodiment of FIG. 6, although radio IC circuitries 606a and 606b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 608a-b may include a WLAN baseband processing circuitry 608a and a BT baseband processing circuitry 608b. The WLAN baseband processing circuitry 608a may include a memory, such as, for example, a set of RAM arrays in a Fast Fourier Transform or Inverse Fast Fourier Transform block (not shown) of the WLAN baseband processing circuitry 608a. Each of the WLAN baseband circuitry 608a and the BT baseband circuitry 608b may further include one or more processors and control logic to process the signals received from the corresponding WLAN or BT receive signal path of the radio IC circuitry 606a-b, and to also generate corresponding WLAN or BT baseband signals for the transmit signal path of the radio IC circuitry 606a-b. Each of the baseband processing circuitries 608a and 608b may further include physical layer (PHY) and medium access control layer (MAC) circuitry, and may further interface with a device for generation and processing of the baseband signals and for controlling operations of the radio IC circuitry 606a-b.

Referring still to FIG. 6, according to the shown embodiment, WLAN-BT coexistence circuitry 613 may include logic providing an interface between the WLAN baseband circuitry 608a and the BT baseband circuitry 608b to enable use cases requiring WLAN and BT coexistence. In addition, a switch 603 may be provided between the WLAN FEM circuitry 604a and the BT FEM circuitry 604b to allow switching between the WLAN and BT radios according to application needs. In addition, although the antennas 601 are depicted as being respectively connected to the WLAN FEM circuitry 604a and the BT FEM circuitry 604b, embodiments include within their scope the sharing of one or more antennas as between the WLAN and BT FEMs, or the provision of more than one antenna connected to each of FEM 604a or 604b.

In some embodiments, the front-end module circuitry 604a-b, the radio IC circuitry 606a-b, and baseband processing circuitry 608a-b may be provided on a single radio card, such as wireless radio card 602. In some other embodiments, the one or more antennas 601, the FEM circuitry 604a-b and the radio IC circuitry 606a-b may be provided on a single radio card. In some other embodiments, the radio IC circuitry 606a-b and the baseband processing circuitry 608a-b may be provided on a single chip or integrated circuit (IC), such as IC 612.

In some embodiments, the wireless radio card 602 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 608b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHZ, 5 GHZ, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

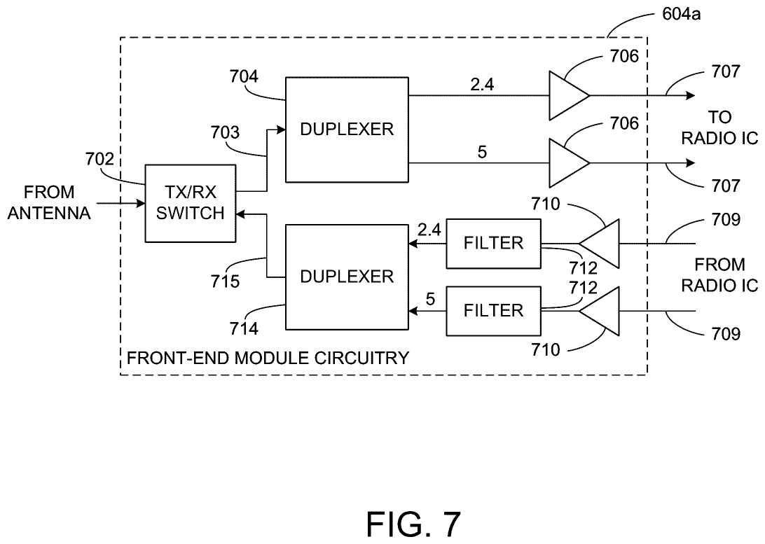

FIG. 7 illustrates WLAN FEM circuitry 604a in accordance with some embodiments. Although the example of FIG. 7 is described in conjunction with the WLAN FEM circuitry 604a, the example of FIG. 7 may be described in conjunction with the example BT FEM circuitry 604b (FIG. 6), although other circuitry configurations may also be suitable.

In some embodiments, the FEM circuitry 604a may include a TX/RX switch 702 to switch between transmit mode and receive mode operation. The FEM circuitry 604a may include a receive signal path and a transmit signal path. The receive signal path of the FEM circuitry 604a may include a low-noise amplifier (LNA) 706 to amplify received RF signals 703 and provide the amplified received RF signals 707 as an output (e.g., to the radio IC circuitry 606a-b (FIG. 6)). The transmit signal path of the circuitry 604a may include a power amplifier (PA) to amplify input RF signals 709 (e.g., provided by the radio IC circuitry 606a-b), and one or more filters 712, such as band-pass filters (BPFs), low-pass filters (LPFs) or other types of filters, to generate RF signals 715 for subsequent transmission (e.g., by one or more of the antennas 601 (FIG. 6)) via an example duplexer 714.

In some dual-mode embodiments for Wi-Fi communication, the FEM circuitry 604a may be configured to operate in either the 2.4 GHz frequency spectrum or the 5 GHz frequency spectrum. In these embodiments, the receive signal path of the FEM circuitry 604a may include a receive signal path duplexer 704 to separate the signals from each spectrum as well as provide a separate LNA 706 for each spectrum as shown. In these embodiments, the transmit signal path of the FEM circuitry 604a may also include a power amplifier 710 and a filter 712, such as a BPF, an LPF or another type of filter for each frequency spectrum and a transmit signal path duplexer 704 to provide the signals of one of the different spectrums onto a single transmit path for subsequent transmission by the one or more of the antennas 601 (FIG. 6). In some embodiments, BT communications may utilize the 2.4 GHz signal paths and may utilize the same FEM circuitry 604a as the one used for WLAN communications.

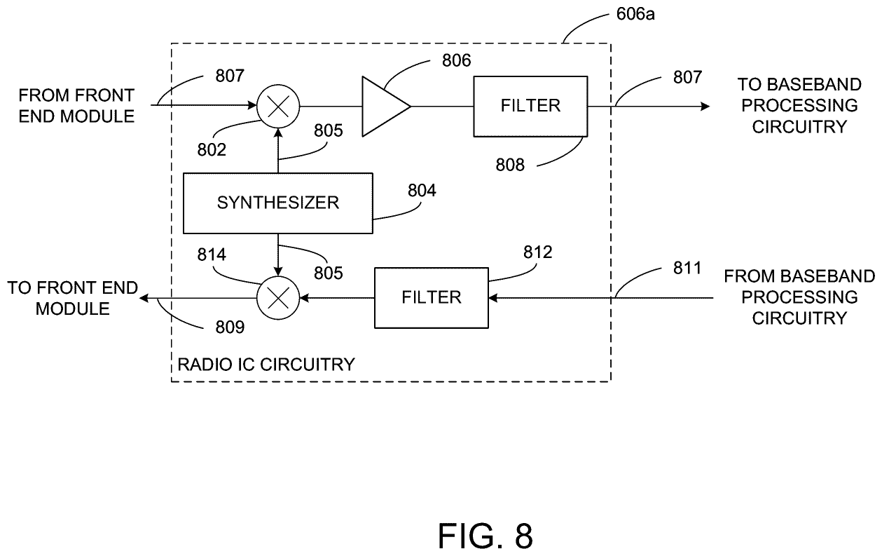

FIG. 8 illustrates radio IC circuitry 606a in accordance with some embodiments. The radio IC circuitry 606a is one example of circuitry that may be suitable for use as the WLAN or BT radio IC circuitry 606a/606b (FIG. 6), although other circuitry configurations may also be suitable. Alternatively, the example of FIG. 8 may be described in conjunction with the example BT radio IC circuitry 606b.

In some embodiments, the radio IC circuitry 606a may include a receive signal path and a transmit signal path. The receive signal path of the radio IC circuitry 606a may include at least mixer circuitry 802, such as, for example, down-conversion mixer circuitry, amplifier circuitry 806 and filter circuitry 808. The transmit signal path of the radio IC circuitry 606a may include at least filter circuitry 812 and mixer circuitry 814, such as, for example, up-conversion mixer circuitry. Radio IC circuitry 606a may also include synthesizer circuitry 804 for synthesizing a frequency 805 for use by the mixer circuitry 802 and the mixer circuitry 814. The mixer circuitry 802 and/or 814 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 8 illustrates only a simplified version of a radio IC circuitry, and may include, although not shown, embodiments where each of the depicted circuitries may include more than one component. For instance, mixer circuitry 814 may each include one or more mixers, and filter circuitries 808 and/or 812 may each include one or more filters, such as one or more BPFs and/or LPFs according to application needs. For example, when mixer circuitries are of the direct-conversion type, they may each include two or more mixers.

In some embodiments, mixer circuitry 802 may be configured to down-convert RF signals 707 received from the FEM circuitry 604a-b (FIG. 6) based on the synthesized frequency 805 provided by synthesizer circuitry 804. The amplifier circuitry 806 may be configured to amplify the down-converted signals and the filter circuitry 808 may include an LPF configured to remove unwanted signals from the down-converted signals to generate output baseband signals 807. Output baseband signals 807 may be provided to the baseband processing circuitry 608a-b (FIG. 6) for further processing. In some embodiments, the output baseband signals 807 may be zero-frequency baseband signals, although this is not a requirement. In some embodiments, mixer circuitry 802 may comprise passive mixers, although the scope of the embodiments is not limited in this respect.

In some embodiments, the mixer circuitry 814 may be configured to up-convert input baseband signals 811 based on the synthesized frequency 805 provided by the synthesizer circuitry 804 to generate RF output signals 709 for the FEM circuitry 604a-b. The baseband signals 811 may be provided by the baseband processing circuitry 608a-b and may be filtered by filter circuitry 812. The filter circuitry 812 may include an LPF or a BPF, although the scope of the embodiments is not limited in this respect.

In some embodiments, the mixer circuitry 802 and the mixer circuitry 814 may each include two or more mixers and may be arranged for quadrature down-conversion and/or up-conversion respectively with the help of synthesizer 804. In some embodiments, the mixer circuitry 802 and the mixer circuitry 814 may each include two or more mixers each configured for image rejection (e.g., Hartley image rejection). In some embodiments, the mixer circuitry 802 and the mixer circuitry 814 may be arranged for direct down-conversion and/or direct up-conversion, respectively. In some embodiments, the mixer circuitry 802 and the mixer circuitry 814 may be configured for super-heterodyne operation, although this is not a requirement.

Mixer circuitry 802 may comprise, according to one embodiment: quadrature passive mixers (e.g., for the in-phase (I) and quadrature phase (Q) paths). In such an embodiment, RF input signal 707 from FIG. 8 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 805 of synthesizer 804 (FIG. 8). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction in power consumption.

The RF input signal 707 (FIG. 7) may comprise a balanced signal, although the scope of the embodiments is not limited in this respect. The I and Q baseband output signals may be provided to low-noise amplifier, such as amplifier circuitry 806 (FIG. 8) or to filter circuitry 808 (FIG. 8).

In some embodiments, the output baseband signals 807 and the input baseband signals 811 may be analog baseband signals, although the scope of the embodiments is not limited in this respect. In some alternate embodiments, the output baseband signals 807 and the input baseband signals 811 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 804 may be a fractional-N synthesizer or a fractional N/N+1 synthesizer, although the scope of the embodiments is not limited in this respect as other types of frequency synthesizers may be suitable. For example, synthesizer circuitry 804 may be a delta-sigma synthesizer, a frequency multiplier, or a synthesizer comprising a phase-locked loop with a frequency divider. According to some embodiments, the synthesizer circuitry 804 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 804 may be provided by a voltage controlled oscillator (VCO), although that is not a requirement. A divider control input may further be provided by either the baseband processing circuitry 608a-b (FIG. 6) depending on the desired output frequency 805. In some embodiments, a divider control input (e.g., N) may be determined from a look-up table (e.g., within a Wi-Fi card) based on a channel number and a channel center frequency as determined or indicated by the example application processor 610. The application processor 610 may include, or otherwise be connected to, one of the example secure signal converter 101 or the example received signal converter 103 (e.g., depending on which device the example radio architecture is implemented in).

In some embodiments, synthesizer circuitry 804 may be configured to generate a carrier frequency as the output frequency 805, while in other embodiments, the output frequency 805 may be a fraction of the carrier frequency (e.g., one-half the carrier frequency, one-third the carrier frequency). In some embodiments, the output frequency 805 may be a LO frequency (fLO).

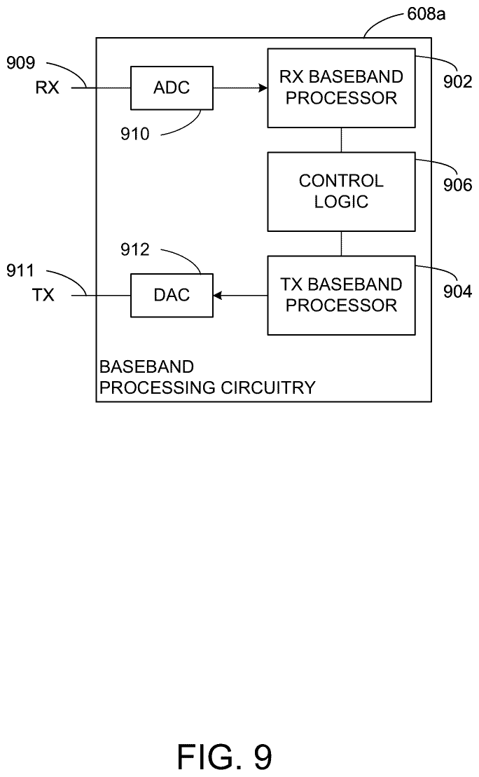

FIG. 9 illustrates a functional block diagram of baseband processing circuitry 608a in accordance with some embodiments. The baseband processing circuitry 608a is one example of circuitry that may be suitable for use as the baseband processing circuitry 608a (FIG. 6), although other circuitry configurations may also be suitable. Alternatively, the example of FIG. 8 may be used to implement the example BT baseband processing circuitry 608b of FIG. 6.

The baseband processing circuitry 608a may include a receive baseband processor (RX BBP) 902 for processing receive baseband signals 809 provided by the radio IC circuitry 606a-b (FIG. 6) and a transmit baseband processor (TX BBP) 904 for generating transmit baseband signals 811 for the radio IC circuitry 606a-b. The baseband processing circuitry 608a may also include control logic 906 for coordinating the operations of the baseband processing circuitry 608a.

In some embodiments (e.g., when analog baseband signals are exchanged between the baseband processing circuitry 608a-b and the radio IC circuitry 606a-b), the baseband processing circuitry 608a may include ADC 910 to convert analog baseband signals 909 received from the radio IC circuitry 606a-b to digital baseband signals for processing by the RX BBP 902. In these embodiments, the baseband processing circuitry 608a may also include DAC 912 to convert digital baseband signals from the TX BBP 904 to analog baseband signals 911.

In some embodiments that communicate OFDM signals or OFDMA signals, such as through baseband processor 608a, the transmit baseband processor 904 may be configured to generate OFDM or OFDMA signals as appropriate for transmission by performing an inverse fast Fourier transform (IFFT). The receive baseband processor 902 may be configured to process received OFDM signals or OFDMA signals by performing an FFT. In some embodiments, the receive baseband processor 902 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 6, in some embodiments, the antennas 601 (FIG. 6) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 601 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: determine, based on a Robust Security Network Extension (RSNXE) field, whether a (Re)Association Frame Encryption Support indication equals one; transmit an authentication frame to initiate fast transition initial mobility domain association; process a second authentication frame received from a fast transition responder (FTR) by extracting a fast transition element (FTE) and a mobility domain element (MDE); and establish a pairwise master key security association (PMKSA) based on the extracted FTE and MDE.

Example 2 may include the device of example 1 and/or some other example(s) herein, wherein the processing circuitry may be further configured to include an MDE in the first authentication frame which may be equal to the MDE advertised in Beacon or Probe Response frames from the FTR or an affiliated AP of the FTR.

Example 3 may include the device of example 1 and/or some other example(s) herein, wherein the processing circuitry may be further configured to process the FTE in the second authentication frame by extracting key holder identities, including R0 Key Holder Identifier (ROKH-ID) and R1 Key Holder Identifier (R1KH-ID)

Example 4 may include the device of example 1 and/or some other example(s) herein, wherein the processing circuitry may be further configured to delete existing PMK-R0 and PMK-R1 security associations when a key hierarchy already exists within the same mobility domain before calculating new PMK-R0, PMKR0Name and PMK-R1 values.

Example 5 may include the device of example 1 and/or some other example(s) herein, wherein the processing circuitry may be further configured to include MDE and FTE in a (Re)Association Request frame with these elements match the corresponding values in the second authentication frame.

Example 6 may include the device of example 1 and/or some other example(s) herein, wherein the processing circuitry may be further configured to include RSNE in the (Re)Association Request frame where the RSNE fields, other than a Length field, PMKID Count field, and PMKID list field, are equal to those in a first authentication frame.

Example 7 may include the device of example 6 and/or some other example(s) herein, wherein the processing circuitry may be further configured to include PMKRIName in the RSNE in the (Re)Association Request frame.

Example 8 may include the device of example 1 and/or some other example(s) herein, wherein the processing circuitry may be further configured to include RSNXE in the (Re)Association Request frame where the RSNXE in a (Re)Association Request frame may be equal to the RSNXE included in a first authentication frame.

Example 9 may include the device of example 1 and/or some other example(s) herein, wherein the processing circuitry may be further configured to use a PMK-R1 key to derive a pairwise transient key (PTK) when a base AKMP may be a fast transition AKMP in an enhanced privacy protection key exchange procedure.

Example 10 may include a non-transitory computer-readable medium storing computer-executable instructions which when executed by one or more processors result in performing operations comprising: determining, based on a Robust Security Network Extension (RSNXE) field, whether a (Re)Association Frame Encryption Support indication equals one; transmitting an authentication frame to initiate fast transition initial mobility domain association; processing a second authentication frame received from a fast transition responder (FTR) by extracting a fast transition element (FTE) and a mobility domain element (MDE); and establishing a pairwise master key security association (PMKSA) based on the extracted FTE and MDE.

Example 11 may include the non-transitory computer-readable medium of example 10 and/or some other example(s) herein, wherein the operations further comprise including an MDE in the first authentication frame which may be equal to the MDE advertised in Beacon or Probe Response frames from the FTR or an affiliated AP of the FTR.

Example 12 may include the non-transitory computer-readable medium of example 10 and/or some other example(s) herein, wherein the operations further comprise processing the FTE in the second authentication frame by extracting key holder identities, including R0 Key Holder Identifier (ROKH-ID) and R1 Key Holder Identifier (R1KH-ID)

Example 13 may include the non-transitory computer-readable medium of example 10 and/or some other example(s) herein, wherein the operations further comprise deleting existing PMK-R0 and PMK-R1 security associations when a key hierarchy already exists within the same mobility domain before calculating new PMK-R0, PMKR0Name and PMK-R1 values.

Example 14 may include the non-transitory computer-readable medium of example 10 and/or some other example(s) herein, wherein the operations further comprise including MDE and FTE in a (Re)Association Request frame with these elements match the corresponding values in the second authentication frame.

Example 15 may include the non-transitory computer-readable medium of example 10 and/or some other example(s) herein, wherein the operations further comprise including RSNE in the (Re)Association Request frame where the RSNE fields, other than a Length field, PMKID Count field, and PMKID list field, are equal to those in a first authentication frame.

Example 16 may include the non-transitory computer-readable medium of example 15 and/or some other example(s) herein, wherein the operations further comprise including PMKR1Name in the RSNE in the (Re)Association Request frame.

Example 17 may include the non-transitory computer-readable medium of example 10 and/or some other example(s) herein, wherein the operations further comprise including RSNXE in the (Re)Association Request frame where the RSNXE in a (Re)Association Request frame may be equal to the RSNXE included in a first authentication frame.

Example 18 may include the non-transitory computer-readable medium of example 10 and/or some other example(s) herein, wherein the operations further comprise using a PMK-R1 key to derive a pairwise transient key (PTK) when a base AKMP may be a fast transition AKMP in an enhanced privacy protection key exchange procedure.

Example 19 may include a method comprising: determining, based on a Robust Security Network Extension (RSNXE) field, whether a (Re)Association Frame Encryption Support indication equals one; transmitting an authentication frame to initiate fast transition initial mobility domain association; processing a second authentication frame received from a fast transition responder (FTR) by extracting a fast transition element (FTE) and a mobility domain element (MDE); and establishing a pairwise master key security association (PMKSA) based on the extracted FTE and MDE.

Example 20 may include the method of example 19 and/or some other example(s) herein, the method further comprising including an MDE in the first authentication frame which may be equal to the MDE advertised in Beacon or Probe Response frames from the FTR or an affiliated AP of the FTR.

Example 21 may include the method of example 19 and/or some other example(s) herein, the method further comprising processing the FTE in the second authentication frame by extracting key holder identities, including R0 Key Holder Identifier (ROKH-ID) and R1 Key Holder Identifier (R1KH-ID)

Example 22 may include the method of example 19 and/or some other example(s) herein, the method further comprising deleting existing PMK-R0 and PMK-R1 security associations when a key hierarchy already exists within the same mobility domain before calculating new PMK-R0, PMKR0Name and PMK-R1 values.

Example 23 may include the method of example 19 and/or some other example(s) herein, the method further comprising including MDE and FTE in a (Re)Association Request frame with these elements match the corresponding values in the second authentication frame.

Example 24 may include the method of example 19 and/or some other example(s) herein, the method further comprising including RSNE in the (Re)Association Request frame where the RSNE fields, other than a Length field, PMKID Count field, and PMKID list field, are equal to those in a first authentication frame.

Example 25 may include the method of example 24 and/or some other example(s) herein, the method further comprising including PMKRIName in the RSNE in the (Re)Association Request frame.

Example 26 may include the method of example 19 and/or some other example(s) herein, the method further comprising including RSNXE in the (Re)Association Request frame where the RSNXE in a (Re)Association Request frame may be equal to the RSNXE included in a first authentication frame.

Example 27 may include the method of example 19 and/or some other example(s) herein, the method further comprising using a PMK-R1 key to derive a pairwise transient key (PTK) when a base AKMP may be a fast transition AKMP in an enhanced privacy protection key exchange procedure.

Example 28 may include an apparatus comprising means for: determining, based on a Robust Security Network Extension (RSNXE) field, whether a (Re)Association Frame Encryption Support indication equals one; transmitting an authentication frame to initiate fast transition initial mobility domain association; processing a second authentication frame received from a fast transition responder (FTR) by extracting a fast transition element (FTE) and a mobility domain element (MDE); and establishing a pairwise master key security association (PMKSA) based on the extracted FTE and MDE.

Example 29 may include the apparatus of example 28 and/or some other example(s) herein, further comprising including an MDE in the first authentication frame which may be equal to the MDE advertised in Beacon or Probe Response frames from the FTR or an affiliated AP of the FTR.

Example 30 may include the apparatus of example 28 and/or some other example(s) herein, further comprising processing the FTE in the second authentication frame by extracting key holder identities, including R0 Key Holder Identifier (ROKH-ID) and R1 Key Holder Identifier (R1KH-ID)

Example 31 may include the apparatus of example 28 and/or some other example(s) herein, further comprising deleting existing PMK-R0 and PMK-R1 security associations when a key hierarchy already exists within the same mobility domain before calculating new PMK-R0, PMKR0Name and PMK-R1 values.

Example 32 may include the apparatus of example 28 and/or some other example(s) herein, further comprising including MDE and FTE in a (Re)Association Request frame with these elements match the corresponding values in the second authentication frame.

Example 33 may include the apparatus of example 28 and/or some other example(s) herein, further comprising including RSNE in the (Re)Association Request frame where the RSNE fields, other than a Length field, PMKID Count field, and PMKID list field, are equal to those in a first authentication frame.

Example 34 may include the apparatus of example 33 and/or some other example(s) herein, further comprising including PMKR1Name in the RSNE in the (Re)Association Request frame.

Example 35 may include the apparatus of example 28 and/or some other example(s) herein, further comprising including RSNXE in the (Re)Association Request frame where the RSNXE in a (Re)Association Request frame may be equal to the RSNXE included in a first authentication frame.

Example 36 may include the apparatus of example 28 and/or some other example(s) herein, further comprising using a PMK-R1 key to derive a pairwise transient key (PTK) when a base AKMP may be a fast transition AKMP in an enhanced privacy protection key exchange procedure.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Example 41 may include a method of communicating in a wireless network as shown and described herein.

Example 42 may include a system for providing wireless communication as shown and described herein.

Example 43 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device comprising processing circuitry coupled to storage, the processing circuitry configured to:
determine, based on a Robust Security Network Extension (RSNXE) field, whether a (Re)Association Frame Encryption Support indication equals one;
transmit an authentication frame to initiate fast transition initial mobility domain association;
process a second authentication frame received from a fast transition responder (FTR) by extracting a fast transition element (FTE) and a mobility domain element (MDE); and
establish a pairwise master key security association (PMKSA) based on the extracted FTE and MDE.

2. The device of claim 1, wherein the processing circuitry is further configured to include an MDE in the first authentication frame which is equal to the MDE advertised in Beacon or Probe Response frames from the FTR or an affiliated AP of the FTR.

3. The device of claim 1, wherein the processing circuitry is further configured to process the FTE in the second authentication frame by extracting key holder identities, including R0 Key Holder Identifier (ROKH-ID) and R1 Key Holder Identifier (R1KH-ID).

4. The device of claim 1, wherein the processing circuitry is further configured to delete existing PMK-R0 and PMK-R1 security associations when a key hierarchy already exists within the same mobility domain before calculating new PMK-R0, PMKR0Name and PMK-R1 values.

5. The device of claim 1, wherein the processing circuitry is further configured to include MDE and FTE in a (Re)Association Request frame with these elements match the corresponding values in the second authentication frame.

6. The device of claim 1, wherein the processing circuitry is further configured to include RSNE in the (Re)Association Request frame where the RSNE fields, other than a Length field, PMKID Count field, and PMKID list field, are equal to those in a first authentication frame.

7. The device of claim 6, wherein the processing circuitry is further configured to include PMKR1Name in the RSNE in the (Re)Association Request frame.

8. The device of claim 1, wherein the processing circuitry is further configured to include RSNXE in the (Re)Association Request frame where the RSNXE in a (Re)Association Request frame is equal to the RSNXE included in a first authentication frame.

9. The device of claim 1, wherein the processing circuitry is further configured to use a PMK-R1 key to derive a pairwise transient key (PTK) when a base AKMP is a fast transition AKMP in an enhanced privacy protection key exchange procedure.

10. A non-transitory computer-readable medium storing computer-executable instructions which when executed by one or more processors result in performing operations comprising:
determining, based on a Robust Security Network Extension (RSNXE) field, whether a (Re)Association Frame Encryption Support indication equals one;
transmitting an authentication frame to initiate fast transition initial mobility domain association;
processing a second authentication frame received from a fast transition responder (FTR) by extracting a fast transition element (FTE) and a mobility domain element (MDE); and
establishing a pairwise master key security association (PMKSA) based on the extracted FTE and MDE.

11. The non-transitory computer-readable medium of claim 10, wherein the operations further comprise including an MDE in the first authentication frame which is equal to the MDE advertised in Beacon or Probe Response frames from the FTR or an affiliated AP of the FTR.

12. The non-transitory computer-readable medium of claim 10, wherein the operations further comprise processing the FTE in the second authentication frame by extracting key holder identities, including R0 Key Holder Identifier (ROKH-ID) and R1 Key Holder Identifier (R1KH-ID).

13. The non-transitory computer-readable medium of claim 10, wherein the operations further comprise deleting existing PMK-R0 and PMK-R1 security associations when a key hierarchy already exists within the same mobility domain before calculating new PMK-R0, PMKR0Name and PMK-R1 values.

14. The non-transitory computer-readable medium of claim 10, wherein the operations further comprise including MDE and FTE in a (Re)Association Request frame with these elements match the corresponding values in the second authentication frame.

15. The non-transitory computer-readable medium of claim 10, wherein the operations further comprise including RSNE in the (Re)Association Request frame where the RSNE fields, other than a Length field, PMKID Count field, and PMKID list field, are equal to those in a first authentication frame.

16. The non-transitory computer-readable medium of claim 15, wherein the operations further comprise including PMKR1Name in the RSNE in the (Re)Association Request frame.

17. The non-transitory computer-readable medium of claim 10, wherein the operations further comprise including RSNXE in the (Re)Association Request frame where the RSNXE in a (Re)Association Request frame is equal to the RSNXE included in a first authentication frame.

18. The non-transitory computer-readable medium of claim 10, wherein the operations further comprise using a PMK-R1 key to derive a pairwise transient key (PTK) when a base AKMP is a fast transition AKMP in an enhanced privacy protection key exchange procedure.

19. A method comprising:
determining, based on a Robust Security Network Extension (RSNXE) field, whether a (Re)Association Frame Encryption Support indication equals one;
transmitting an authentication frame to initiate fast transition initial mobility domain association;
processing a second authentication frame received from a fast transition responder (FTR) by extracting a fast transition element (FTE) and a mobility domain element (MDE); and
establishing a pairwise master key security association (PMKSA) based on the extracted FTE and MDE.

20. The method of claim 19, the method further comprising including an MDE in the first authentication frame which is equal to the MDE advertised in Beacon or Probe Response frames from the FTR or an affiliated AP of the FTR.
